(19) United States
(12) Patent Application Publication
(10) Pub. No.: US 2011/0261396 A1
(43) Pub. Date: Oct. 27, 2011

(54) CONTROL DEVICE FOR MANAGING DRIVERS

(75) Inventor: Nobuharu TAKAHASHI, Nagoya-shi (JP)

(73) Assignee: BROTHER KOGYO KABUSHIKI KAISHA, Nagoya-shi (JP)

(21) Appl. No.: 13/034,872

(22) Filed: Feb. 25, 2011

(30) Foreign Application Priority Data
Apr. 27, 2010 (JP) 2010-102322

(51) Int. Cl. G06F 3/12

(52) U.S. Cl. 358/1.15

(57) ABSTRACT

A universal driver capable of controlling an image process in a plurality of types of image processing devices is installed in a control device. The control device includes a control unit, a first selecting unit, and a management unit. The first selecting unit selects a most frequently used image processing device among a plurality of image processing devices used under the control of the control unit. The management unit performs an installation prompting process for executing selected one of an installation of a first specialized driver, which is more specialized for the most frequently used image processing device than the universal driver and is capable of controlling the image process in the most frequently used image processing device, and an issuing of a notification for prompting the installation.

### CROSS REFERENCE TO RELATED APPLICATION

This application claims priority from Japanese Patent Application No. 2010-102322 filed Apr. 27, 2010. The entire content of this priority application is incorporated herein by reference.

### TECHNICAL FIELD

The present invention relates to a control device, a computer readable storage medium storing a control program, and a driver management method, and particularly to such a control device, a computer readable storage medium, and a driver management method for managing drivers whose function is to control image processors.

### BACKGROUND

When a personal computer controls a printer to perform printing operations, generally a printer driver provided specifically for this printer is used on the personal computer for performing various print settings and for issuing print commands to the printer. However, in more recent years, personal computers have used a single driver capable of controlling a plurality of types of printers (see Japanese patent application publication No. 2009-301312). This driver is referred to as a universal printer driver. Thus, in an environment that requires a single computer to use multiple printers of different types, this universal printer driver enables the computer to use all printers without having to install a specialized printer driver for each printer.

### SUMMARY

However, such universal printer drivers normally possess only basic functions, without all the functions available in the specialized printer driver.

In view of the foregoing, it is an object of the present invention to provide a control device, a computer readable storage medium storing a control program, and a driver management method capable of improving user-friendliness when employing drivers to control image processors.

In order to attain the above and other objects, the present invention provides a control device. A universal driver capable of controlling an image process in a plurality of types of image processing devices is installed in the control device. The control device includes a control unit, a first selecting unit, and a management unit. The first selecting unit selects a most frequently used image processing device among a plurality of image processing devices used under the control of the control unit. The management unit performs an installation prompting process for executing selected one of an installation of a first specialized driver, which is more specialized for the most frequently used image processing device than the universal driver and is capable of controlling the image process in the most frequently used image processing device, and an issuing of a notification for prompting the installation.

According to another aspect, the present invention provides a non-transitory computer readable storage medium storing a set of program instructions installed on and executed by a computer for controlling a control device on which a universal driver capable of controlling an image process in a plurality of types of image processing devices is installed. The program includes, selecting a most frequently used image processing device among a plurality of image processing devices used under the control of the control device, and performing an installation prompting process for executing selected one of an installation of a specialized driver, which is more specialized for the most frequently used image processing device than the universal driver and is capable of controlling the image process in the most frequently used image processing device, and an issuing of a notification for prompting the installation.

According to still another aspect, the present invention provides a driver management method for controlling a control device on which a universal driver capable of controlling an image process in a plurality of types of image processing devices is installed. The driver management method includes selecting a most frequently used image processing device among a plurality of image processing devices used under the control of the control device, and performing an installation prompting process for executing selected one of an installation of a specialized driver, which is more specialized for the most frequently used image processing device than the universal driver and is capable of controlling the image process in the most frequently used image processing device, and an issuing of a notification for prompting the installation.

### BRIEF DESCRIPTION OF THE DRAWINGS

The particular features and advantages of the invention as well as other objects will become apparent from the following description taken in connection with the accompanying drawings, in which:

FIG. 1 is a block diagram illustrating a system according to an embodiment of the present invention;

FIG. 2 is a block diagram conceptually illustrating a software installed in a HDD;

FIG. 3 is a diagram showing a print command window;

FIG. 4 is a diagram showing a print settings window of a universal printer driver;

FIG. 5 is a table showing a count data;

FIG. 6 is a flowchart of a printer driver management process;

FIG. 7 is a flowchart of the printer driver management process; and

FIG. 8 is a table showing one example of adding up the number of uses for the printers.

### DETAILED DESCRIPTION

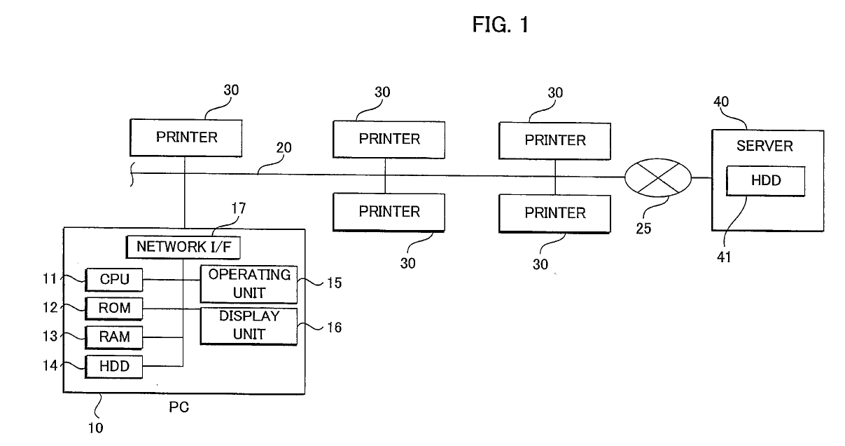

As shown in FIG. 1, a system of the present invention includes a personal computer (PC) 10, a plurality of printers 30, and a server 40.

The PC 10 is provided with a CPU 11, a ROM 12, a RAM 13, a hard disk drive (HDD) 14, an operating unit 15 including a keyboard and a pointing device, a display unit 16 including a display, and a network interface (I/F) 17.

The CPU 11 performs overall operation of the PC 10. The network interface 17 is connected to a communication network 20 in an intranet such as Local Area Network (LAN). The plurality of printers 30 is connected to the communication network 20, and the PC 10 can communicate with these printers 30 via the network interface 17.

The communication network 20 is connected to an external network 25 such as an Internet via a router (not shown). The server 40 having a HDD 41 storing a downloadable printer driver described later is provided on the external network 25.

The plurality of printers 30 connected to the communication network 20 may be various types of printers. A new printer not shown in FIG. 1 may be connected to the communication network 20, or any of the printers 30 may be disconnected from the communication network 20. The PC 10 may be a portable laptop PC connected to another network so as to operate a printer connected to the another network.

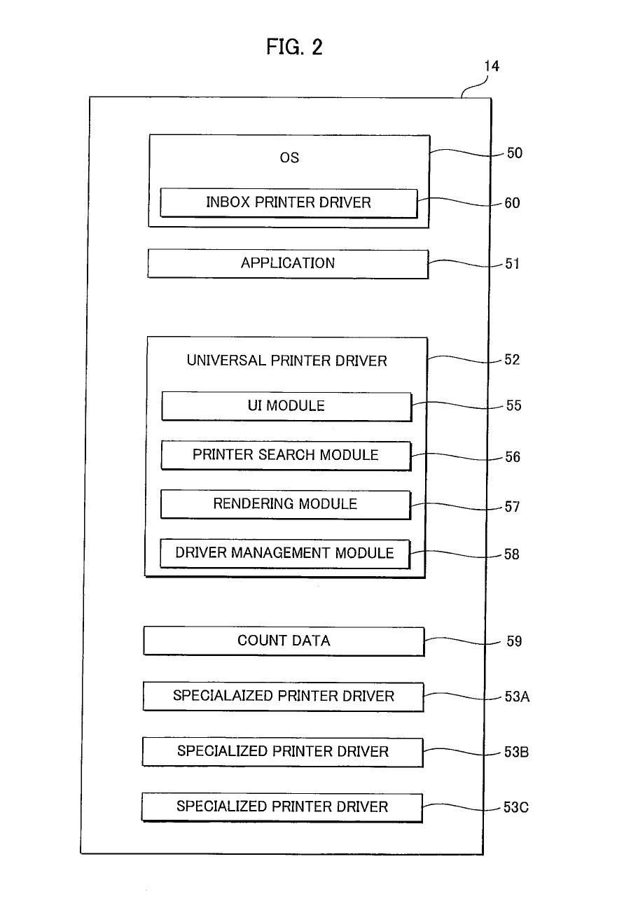

As shown in FIG. 2, the HDD 14 stores an operating system (OS) 50, an application program 51 (hereinafter abbreviated to “application”), various types of printer drivers 52, 53A, 53B, and 53C, and count data 59.

In this embodiment, the OS 50 is Windows (registered trademark) of Microsoft having a basic program for performing a printing operation using an installed printer driver. The application 51 has functions for generating print data of letters, characters, photographs, and the like.

Two types of printer drivers are installed on the PC 10; namely, a universal printer driver 52, and three specialized printer drivers 53A-53C. Printer ports associated with each of the printer drivers 52 and 53A-53C are registered in the OS 50.

The universal printer driver 52 is a driver that can be used universally among a variety of types (models) of printers. The universal printer driver 52 includes a user interface (UI) module 55, a printer search module 56, a rendering module 57, and a driver management module 58.

The UI module 55 controls the display unit 16 and the operating unit 15 to provide a graphical user interface for allowing the user to input print settings and the like. The printer search module 56 searches for available printers and acquires information from these printers. The rendering module 57 generates print data by converting data created by the application 51 to a format supported on the printer. The driver management module 58 manages the installed printer drivers using the count data 59.

Each of the specialized printer drivers 53A-53C is a driver dedicated to a specific printer model and includes, not show in FIG. 2, a UI module for controlling the display unit 16 and the operating unit 15 to allow printer settings and the like, a rendering module for generating print data, and the like. Each of the specialized printer drivers 53A-53C can be provided with a larger number of configurable functions than the universal printer driver 52. Specifically, for example, each of the specialized printer drivers 53A-53C possesses functions directly dependent on the corresponding printer 30 for fine-tuning image quality which function is not provided to the universal printer driver 52.

Further, the specialized printer drivers 53A-53C may be configured to perform more advanced settings than the universal printer driver 52, even for functions common to the universal printer driver 52. For example, an N-in-1 printing function possessed by the universal printer driver 52 allows for the two settings “2-in-1” (printing images of two pages in a reduced size on one sheet) and “4-in-1”; while the same function on the specialized printer driver includes the four settings “2-in-1,” “4-in-1,” “9-in-1,” and “16-in-1.” The specialized printer drivers 53A-53C may support at least one printer model, but may support a plurality of models, provided that each specialized printer drivers 53A-53C is at least more specialized than the universal printer driver 52.

Further, the OS 50 is provided with a plurality of in-box printer drivers 60 that have not yet been installed (that have not yet been associated with printer ports, for example). A plurality of these in-box printer drivers 60 is provided to support a plurality of printer models. The in-box printer drivers 60 are specialized printer drivers that are more specialized than the universal printer driver 52. However, in some cases, the in-box printer drivers 60 may have fewer functions or may be older versions than printer drivers stored in the HDD 41 of the server 40.

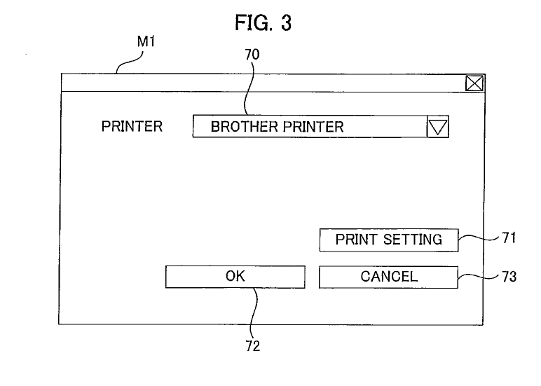

When the application 51 is executing on the PC 10 and the user inputs a print command through the operating unit 15, the CPU 11 displays a print command window M1, as shown in FIG. 3, on the display unit 16. The print command window M1 includes a printer selection drop-down list 70, a print settings button 71, an OK button 72, and a cancel button 73.

The printer selection drop-down list 70 can display a plurality of printer names in a list, enabling the user to select one of the printer names displayed in the list using the operating unit 15. The printer names displayed in the printer selection drop-down list 70 include a printer name of a single virtual printer corresponding to a plurality of printer names for the universal printer driver 52 and the names of printers controlled by the specialized printer drivers 53A-53C. These printer names are registered in the OS 50 and associated to printer ports.

When the user clicks on the print settings button 71 in the print command window M1, the CPU 11 calls the UI module of the printer driver corresponding to the printer name selected in the printer selection drop-down list 70 and displays a print settings window on the display unit 16 through the UI module. In the print settings window, the user can modify various printing conditions using the operating unit 15.

When a printer name other than that of the single virtual printer corresponding to the universal printer driver 52, i.e., the printer name of the specialized printer driver 53A-53C, has been selected in the printer selection drop-down list 70 and the user clicks on the OK button 72 in the print command window M1, the CPU 11 calls the rendering module of the specialized printer driver associated with the selected printer name. This rendering module generates print data by converting the data created by the application 51 into a prescribed format, such as a page description language (PDL), and transmits the print data to the selected printer via the corresponding printer port.

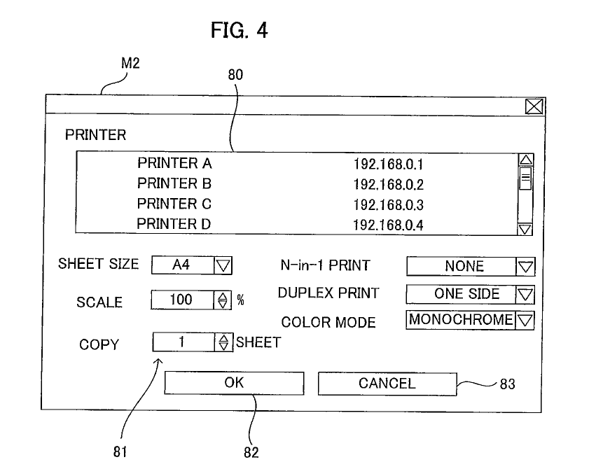

When the printer name of the single virtual printer corresponding to the universal printer driver 52 has been selected in the printer selection drop-down list 70 and the user clicks on the OK button 72 in the print command window M1, on the other hand, the CPU 11 calls the UI module 55 of the universal printer driver 52 and displays a print settings window M2 shown in FIG. 4 on the display unit 16. This print settings window M2 includes a printer list display section 80, a settings section 81, an OK button 82, and a cancel button 83.

After the print settings window M2 is displayed, the CPU 11 searches for printers 30 connected to the PC 10 using the printer search module 56 of the universal printer driver 52. For example, the CPU 11 broadcasts a request on the communication network 20 via the network interface 17 to acquire printer names in order to search for the printers 30 connected to the communication network 20. When a response is received from the printer 30, the CPU 11 queries the printer 30 for printer data, such as a model, an IP address, available functions, and a current status, and acquires this printer information.

The available functions indicate what functions the printer possesses, such as a duplex print function, a staple function, and a color print function, as well as information indicating the capacity of the printer, such as the maximum resolution and the printing speed. Next, the CPU 11 displays the printer name, an IP address, and other information for all printers 30 found by the printer search module 56 in the printer list display section 80 of the print settings window M2. At this time, the user can select a desired printer for printing the current job from among the printers displayed in the printer list display section 80 using the operating unit 15.

In the settings section 81 of the print settings window M2, the user can set various printing conditions using the operating unit 15. Here, setting values and functions not available in the printer selected in the printer list display section 80 may be grayed out or not displayed in the settings section 81, preventing selection by the user.

When the user clicks on the OK button 82, the CPU 11 receives the data created by the application 51 and generates print data by converting the received data to a prescribed format, such as a PDL, using the rendering module 57. Next, the CPU 11 transmits the print data to the printer selected in the printer list display section 80 via the network interface 17. Upon receiving the print data, the printer 30 performs the printing operation according to the printing instructions included in the print data.

Next, a counting process executed by the CPU 11 according to the driver management module 58 of the universal printer driver 52 will be described. The counting process is performed to count the number of uses of each printer. The driver management module 58 runs as a resident program for monitoring activity at the printer ports. When print data (printing instructions) is outputted from the printer port, the usage of the destination printer is recorded in the count data 59 stored on the HDD 14. Using the driver management module 58, it is possible to monitor print commands for the universal printer driver 52 or the specialized printer drivers 53A-53C at the printer ports.

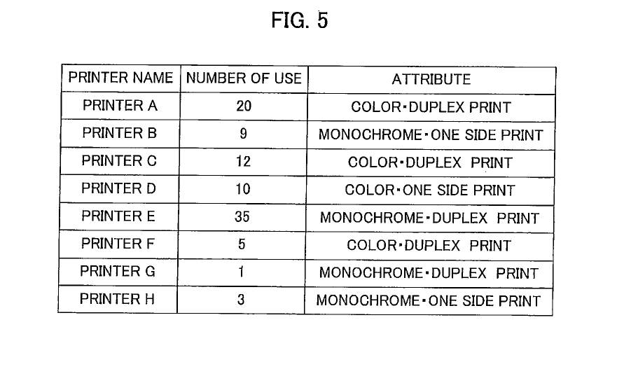

As shown in FIG. 5, the count data 59 includes various data for each printer 30 used by the PC 10, including such data as the printer name, the number of uses, and the attributes. The attribute in the embodiment may indicate whether the printer supports color or monochrome-only print, whether the printer supports duplex print or only one-side print, and the like. The number of uses for each printer in the count data 59 may be reset at one of prescribed intervals and a time when the number of uses reaches a prescribed value, for example. Alternatively, rather than resetting the number of uses for each printer, the number of uses may be recorded in the count data 59 from when the universal printer driver 52 is first used.

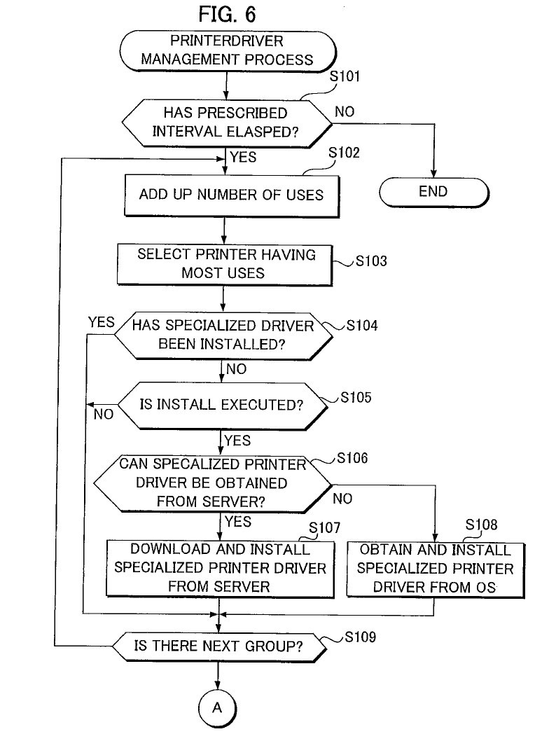

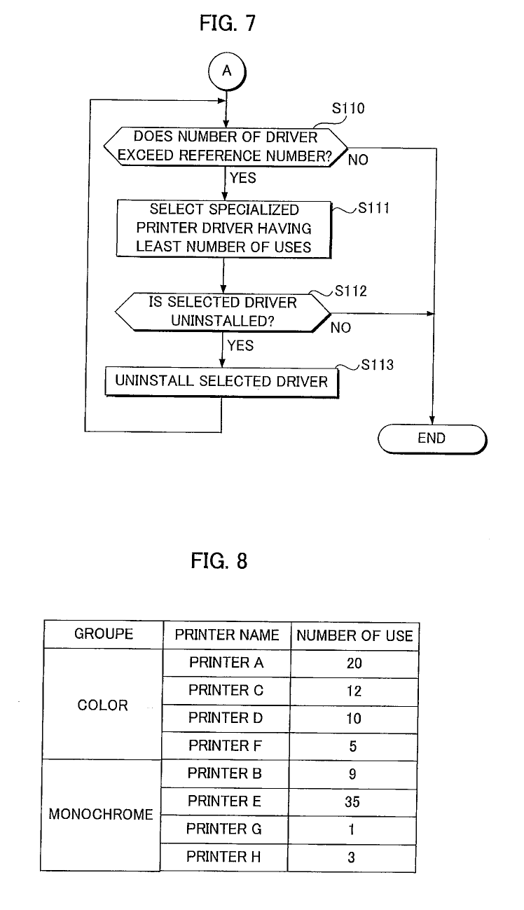

In addition to the counting process described above, the driver management module 58 repeatedly executes a printer driver management process shown in FIGS. 6 and 7 at predetermined intervals. The printer driver management process can be broadly divided into an installation prompting process for prompting installation of a printer driver, and an uninstallation prompting process for prompting uninstallation of a printer driver.

In 5101 at the beginning of the printer driver management process shown in FIG. 6, the CPU 11 determines whether a prescribed interval has elapsed since the previous installation prompting process. If not (S101: NO), then the CPU 11 ends the current printer driver management process. However, if so (S101: YES), then the CPU 11 executes the installation prompting process in S102-S109. Hence, the installation prompting process of the embodiment is executed at the prescribed intervals. Alternatively, the installation prompting process (at least a process for selecting installation candidates in S103 described later) may be executed each time the printing operation has been performed a prescribed number of times since the previous installation prompting process. Still alternatively, the installation prompting process may be executed when either of a condition that the prescribed interval has elapsed or a condition that the printing operation has been performed the prescribed number of times is met.

If a positive determination has been made in 5101, then in 5102 the CPU 11 adds up the number of uses for each printer 30 based on the count data 59 described above. Specifically, the CPU 11 sorts the printers 30 registered in the count data 59 into a plurality of groups based on their attributes and acquires the number of uses for each printer 30 in each group. Here, the data acquired by the printer search module 56 described earlier may be used as data related to the attributes of the printers 30. FIG. 8 shows one example of adding up the number of uses for the printers 30 after sorting the printers 30 into a group that supports color print and a group that only supports monochrome print.

In S103 the CPU 11 selects a printer having the most uses among printers in one of the plurality of groups as a printer candidate for installing a printer driver. Using the example of FIG. 8, the CPU 11 selects printer A when selecting the group that supports color print, or printer E when selecting the group that only supports monochrome print.

In S104 the CPU 11 determines whether a specialized printer driver has been already installed for the selected printer 30. If not (S104: NO), then in S105 the CPU 11 displays a dialog box on the display unit 16 prompting the user to select whether to install the specialized printer driver. If the user performs an operation on the operating unit 15 indicating a desire to install the printer driver (S105: YES), then in S106 the CPU 11 determines whether the specialized printer driver can be obtained from the server 40. This determination may be made based on whether the CPU 11 can access the Internet through the network interface 17 or based on the results of querying the server 40 regarding whether the specialized printer driver is obtainable.

If so (S106: YES), then in S107 the CPU 11 downloads this specialized printer driver from the server 40, saves the specialized printer driver on the HDD 14, and installs this driver. However, if not (S106: NO), then in S108 the CPU 11 obtains the corresponding specialized printer driver from the in-box printer drivers 60 of the OS 50 and installs this driver.

Further, if the CPU 11 determines in S104 that the specialized printer driver has already been installed (S104: YES) or if the CPU 11 determines in S105 that the user has specified a desire not to install the specialized printer driver (S105: NO) or after the CPU 11 has installed the specialized printer driver in S107 or S108, then in S109 the CPU 11 determines whether there are any groups from which an installation candidate has not yet been selected. If so (S109: YES), then the CPU 11 returns to S103 and the CPU 11 repeats the above process for these groups. If not (S109: NO), then the CPU 11 ends the current installation prompting process and advances to S110 in FIG. 7.

In the installation prompting process described above, the process in S105 may be omitted so that the CPU 11 immediately begins installing the specialized printer driver without querying the user whether to install the driver. Further, rather than installing the specialized printer driver in the installation prompting process, the CPU 11 may display a notification on the display unit 16, such as “It is recommended that you install the specialized printer driver for Printer A,” prompting the user to install the selected driver. Alternatively, the CPU 11 may display a link (URL) to a Web site from which the specialized printer driver can be obtained, enabling the user to access and obtain the specialized printer driver from the Web page using a browser, or may automatically display the Web page in the browser.

After completing the installation prompting process, in S110 of FIG. 7 the CPU 11 determines whether the number of specialized printer drivers installed on the PC 10 exceeds a prescribed reference number. If not (S110: NO), then the CPU 11 ends the printer driver management process. However, if so (S110: YES), then the CPU 11 executes the uninstallation prompting process in S111-S113.

In S111 the CPU 11 selects an installed specialized printer driver having the least number of uses as an uninstallation candidate. In S112 the CPU 11 displays a message on the display unit 16 prompting the user to confirm whether to uninstall the specialized printer driver selected in S111. If the user indicates on the operating unit 15 a desire not to uninstall the selected printer driver (S112: NO), the CPU 11 ends the printer driver management process without uninstalling the specialized printer driver. However, if the user confirms on the operating unit 15 a desire to uninstall the selected driver (S112: YES), then in S113 the CPU 11 uninstalls the selected specialized printer driver.

By uninstalling the specialized printer driver in S113, the CPU 11 eliminates the registered association between the specialized printer driver and its printer port. Consequently, the printer name associated with this specialized printer driver is eliminated from the printer selection drop-down list 70 of the print command window M1. In the uninstallation prompting process described above, the CPU 11 may either delete the specialized printer driver from the HDD 14 or leave the specialized printer driver on the HDD 14, provided that the specialized printer driver at least cannot be called and executed by an application.

After uninstalling the specialized printer driver, the CPU 11 returns to S110 and repeats the uninstallation prompting process while the number of specialized printer drivers remains over the prescribed reference number (S110: YES). The CPU 11 ends the printer driver management process when determining that the number of specialized printer drivers does not exceed the reference number (S110: NO).

In the uninstallation prompting process described above, the process in S112 may be omitted so that the CPU 11 immediately uninstalls the selected specialized printer driver in S113 without querying the user whether to uninstall the specialized printer driver. Alternatively, rather than uninstalling the printer driver, the CPU 11 may simply display a notification on the display unit 16, such as “It is recommended that you uninstall the specialized printer driver for Printer A,” prompting the user to uninstall the selected specialized printer driver.

In the embodiment described above, the PC 10 on which the universal printer driver 52 is installed executes the installation prompting process to select the most frequently used printer 30 among all printers 30 that can be controlled by the PC 10 and to install or prompt the user to install a specialized printer driver for this printer 30 that is more specialized than the universal printer driver 52. Installing a specialized printer driver for the most frequently used printer 30 in this way is more convenient for the user.

In the embodiment, the printer name of the printer, which is controlled by the installed specialized printer driver, is displayed in the printer selection drop-down list 70 of the print command window M1 while other printer names of the printer controlled by the universal printer driver 52 are displayed in the printer list display section 80 of the print settings window M2. Since only the printer name(s) of the printer(s) controlled by the installed specialized printer driver is displayed in the printer selection drop-down list 70, the user can easily choice a desired printer among the printers 30 connected to the PC 10.

Conversely, not installing specialized printer drivers for printers 30 with low usage eliminates some troublesome installation operations. Further, since it is likely that these printers 30 will be used with low frequency in the future as well, the disadvantages of using a universal printer driver, i.e., fewer functions than when using a specialized printer driver, can be minimized.

Further, the user generally will select the printer 30 based on the objective for image processing, for example. The PC 10 can also select a more preferable printer 30 (image processor) as the target of the installation prompting process by sorting all available printers 30 into a plurality of groups based on their attributes and selecting a printer 30 from each group. By installing the specialized printer driver for each group in this way, the printer 30 capable of using the specialized printer driver is always available when the user wishes to perform image processing using an attribute of one of these groups, improving convenience for the user.

For example, a printer that supports color print may be used when the user wishes to print a color photograph, while a monochrome-only printer capable of printing faster and at a lower cost than the color printer may be used when the user is printing text. Installing the specialized printer driver for the most frequently used printer in both the group supporting color print and the group supporting only monochrome print increases the likelihood that print commands can be issued using the specialized printer driver whether the user is printing color photographs or text, thereby improving user-friendliness.

Further, the PC 10 selects the printer 30 and installs the corresponding specialized printer driver for the selected printer 30 when at least one of a condition that the prescribed interval has elapsed since the previous installation prompting process and a condition that the image process has been executed a prescribed number of times since the previous installation prompting process is satisfied. Accordingly, if the most commonly used printer changes during different time periods, the PC 10 can install the specialized printer driver for the printer that is most likely to be used during each time period.

The PC 10 also executes the uninstallation prompting process to select a specialized printer driver from among all installed specialized printer drivers that is used least frequently and to uninstall or prompt the user to uninstall the selected specialized printer driver. In this way, the PC 10 can reduce the number of installed specialized printer drivers. This process also reduces the number of printer names displayed in the printer selection drop-down list 70 of the print command window M1, simplifying the user's operation for selecting a desired printer (printer driver).

The PC 10 executes the uninstallation prompting process when the number of installed specialized printer drivers has exceeded the prescribed reference number. Accordingly, the PC 10 can keep the number of installed specialized printer drivers to an appropriate number.

The PC 10 can also obtain the specialized printer driver needed for the installation prompting process from the server 40 on the network or from the HDD 14 in the PC 10 itself. Since the specialized printer drivers that can be obtained from the server 40 on the network are generally more suitable than the specialized printer drivers that can be obtained from the HDD 14, the PC 10 gives priority to the specialized printer drivers on the server 40, thereby ensuring that the most suitable specialized printer driver is installed.

The PC 10 of the embodiment also enhances user-friendliness by installing specialized printer drivers in the installation prompting process having a greater number of available functions than the universal printer driver 52.

While the invention has been described in detail with reference to specific embodiment thereof, it would be apparent to those skilled in the art that many modifications and variations may be made therein without departing from the spirit of the invention, the scope of which is defined by the attached claims.

(1) In the embodiment, the present invention is applied to a device that controls printing using a printer driver, but the present invention may be applied to a device for controlling an image process using a fax driver, scanner driver, or other driver.

For example, fax drivers installed in the Windows (registered trademark) operating system are associated with ports essentially the same as printer drivers are associated with printer ports. In the system shown in FIG. 1, a plurality of facsimile devices may be connected to the communication network 20, for example. When the PC 10 is transmitting a fax using one of the facsimile devices, the application 51 displays the print command window M1, enabling the user to select an installed fax driver from the printer selection drop-down list 70.

With this construction, a fax driver that can be used universally for a plurality of types of facsimile devices is pre-installed on the PC 10. Thus, the PC 10 can execute an installation prompting process to select the facsimile device used most frequently and to install a specialized fax driver for this facsimile device. The PC 10 can also execute an uninstallation prompting process for uninstalling the fax driver used least frequently.

Similarly, when scanner devices supporting the TWAIN standard software protocol are connected to the communication network 20 in FIG. 1, scanner drivers may be installed on the PC 10 for use when the PC 10 executes a scanning operation using one of the scanners. Here, the user of the PC 10 launches an application that supports the TWAIN standard for handling images, selects a device to perform the scan (scanner driver) using the operating unit 15, and inputs a scan execution command, at which time the corresponding scanner reads an original and outputs scan data. Thus, the user can incorporate this scan data in the application.

With this construction, the scanner driver that can be used universally for a plurality of types of scanning devices is pre-installed on the PC 10. Thus, the PC 10 can execute the installation prompting process to select the scanner driver used most frequently and to install a specialized scanner driver for the selected driver. The PC 10 can also execute the uninstallation prompting process to uninstall the scanner driver used least frequently.

(2) In the embodiment described above, the PC 10 (control device) controls the printers 30 connected to the communication network 20 via the network interface 17. However, the PC 10 may be provided with a USB interface, parallel interface (parallel port), or the like and may be connected to the printers 30 or other image processors through these interfaces rather than the network interface 17. Accordingly, the present invention may be applied to drivers used for these image processors.

(3) In the embodiment described above, the driver management module 58 of the universal printer driver 52 is used to execute the counting process for counting the number of uses for printers, the installation prompting process, and the uninstallation prompting process. However, the present invention may be applied to processes executed according to separate programs from the universal printer driver 52.

(4) In the embodiment described above, the PC 10 executes the installation prompting process and the uninstallation prompting process. However, the PC 10 may be configured to only execute the installation prompting process.

(5) Further, the method of selecting a driver to be installed in the installation prompting process or the method of selecting a driver to be uninstalled in the uninstallation prompting process may be modified as necessary. For example, in the installation prompting process, the PC 10 may select all image processors whose number of uses exceeds the prescribed reference number. Similarly, in the uninstallation prompting process the PC 10 may select all drivers whose number of uses is no greater than the prescribed reference number.

(6) Further, the PC 10 may select a different driver when the user specifies a desire not to install or uninstall the currently selected driver. Alternatively, the PC 10 may store this specification by the user so as to not select the driver in question for installation or uninstallation thereafter.

(7) The PC 10 selects a printer (printer driver) from each group as a target for the installation prompting process. However, the present invention may be applied to a control device that does not sort the printers according to groups before making a selection, or that selects printers only from some of the groups. Further, the PC 10 may select a driver from each group as targets for the uninstallation prompting process, as in the installation prompting process.

(8) In the example described in the embodiment, the printers 30 are sorted into a group that supports color print and a group that supports only monochrome print. However, the printers 30 may be sorted into groups based on different attributes. For example, printers may be sorted according to their printing system, such as an electrophotographic system or an inkjet system, or may be sorted based on their image. processing functions and capabilities, such as the possession of a duplex printing function, their printing speed, or their printing resolution. Alternatively, the printers may be sorted based on their location.

(9) The number of times that a printing command is outputted to each printer 30 is counted as the number of uses for that printer 30. However, the number of uses according to the present invention may include the frequency of use for each image processor, the percentage of their use (the ratio of print commands outputted to each printer relative to all print commands outputted from the PC, for example), and the number of printed pages (or the number of pages transmitted by fax or the number of scanned pages).

(10) In the embodiment described above, the number of uses is counted for printers used by the universal printer driver 52 and for printers used by the specialized printer drivers 53A-53C. However, the number of uses may be counted in the installation prompting process only for image processors used by the universal printer driver 52, while the number of uses may be counted in the uninstallation prompting process only for the specialized printer drivers 53A-53C.

(11) In the embodiment described above, the PC 10 obtains the specialized printer drivers to be installed from the server 40 or the HDD 14. However, a connector unit capable of connecting other media, such as a CD-ROM, to the control device may be provided so that the control device can read and install drivers stored in the media connected to the connector unit.

What is claimed is:

1. A control device on which a universal driver capable of controlling an image process in a plurality of types of image processing devices is installed, the control device comprising:
a control unit;
a first selecting unit that selects a most frequently used image processing device among a plurality of image processing devices used under the control of the control unit; and
a management unit that performs an installation prompting process for executing selected one of an installation of a first specialized driver, which is more specialized for the most frequently used image processing device than the universal driver and is capable of controlling the image process in the most frequently used image processing device, and an issuing of a notification for prompting the installation.

2. The control device according to claim 1, wherein the first selecting unit sorts the plurality of image processing devices into a plurality of groups and selects the most frequently used image processing device from each group.

3. The control device according to claim 1, wherein the first selecting unit selects the most frequently used image processing device when one of a first condition that a prescribed time duration has elapsed since a previous selection by the first selecting unit and a second condition that the image process has been executed a prescribed number of times since the previous selection is satisfied.

4. The control device according to claim 1, further comprising a second selecting unit that selects a second specialized driver used least frequently among a plurality of installed specialized drivers,
wherein the management unit performs an uninstallation prompting process for executing selected one of an uninstallation of the second specialized driver and an issuing of a notification for prompting the uninstallation.

5. The control device according to claim 4, wherein the management unit performs the uninstallation prompting process when the number of the installed specialized drivers exceeds a reference number.

6. The control device according to claim 1, further comprising a communication unit communicable with a storage device storing a third specialized driver located on a network, and a storing unit storing a fourth specialized driver that has not yet been installed,
wherein, during the installation prompting process, the management unit obtains the third specialized driver as the first specialized driver from the storage device if the third specialized driver is obtainable from the storage device, and the management unit obtains the fourth specialized driver as the first specialized driver from the storing unit if the third specialized driver is unobtainable from the storage device.

7. The control device according to claim 1, wherein the first specialized driver has a larger number of usable functions than the universal driver.

8. A non-transitory computer readable storage medium storing a set of program instructions installed on and executed by a computer for controlling a control device on which a universal driver capable of controlling an image process in a plurality of types of image processing devices is installed, the program comprising:
selecting a most frequently used image processing device among a plurality of image processing devices used under the control of the control device; and
performing an installation prompting process for executing selected one of an installation of a specialized driver, which is more specialized for the most frequently used image processing device than the universal driver and is capable of controlling the image process in the most frequently used image processing device, and an issuing of a notification for prompting the installation.

9. A driver management method for controlling a control device on which a universal driver capable of controlling an image process in a plurality of types of image processing devices is installed, the driver management method comprising:
selecting a most frequently used image processing device among a plurality of image processing devices used under the control of the control device; and
performing an installation prompting process for executing selected one of an installation of a specialized driver, which is more specialized for the most frequently used image processing device than the universal driver and is capable of controlling the image process in the most frequently used image processing device, and an issuing of a notification for prompting the installation.
